(19) United States
(12) Patent Application Publication
(10) Pub. No.: US 2010/0120280 A1
(43) Pub. Date: May 13, 2010

(54) CONNECTOR HAVING THREE-WAY INTERCONNECTION

(75) Inventors: GUO-JIAN SHEN, Kunshan (CN); CHI ZHANG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/616,707

(22) Filed: Nov. 11, 2009

(30) Foreign Application Priority Data
Nov. 11, 2008 (CN) 200820217798.5

(51) Int. Cl. H01R 13/62

(52) U.S. Cl. 439/329

(57) ABSTRACT

An electrical connector (100) for electrically mating with two different mating interfaces includes an insulative housing (1) defining a first and a second mating spaces (114, 124) located at opposite ends, a plurality of contact terminals (2) received in the insulative housing (1) each of which integrally defines an upper beam (2a), a lower beam (2b), and a fulcrum portion (21) connecting the beams at middle thereof, an actuator (4) pivotally assembled on the housing (1) and capable of rotating between an opened position in which one of the mating spaces (124) is accessible, and a closed position in which the actuator (4) is substantially covering said mating space (124). Each contact terminal (2) forms a first contact portion (221, 231) extending toward a first mating space (114) from the fulcrum portion (21), a second contact portion (251) extending toward a second mating space (124) from the fulcrum portion (21), and a soldered portion (252) solderable onto a PCB (400) which the electrical connector (100) located thereon or therein.

### BACKGROUND OF THE INVENTION

1. Field of the Invention

The present invention relates to an adaptor, and more particularly, to a connector having an FPC interface at one end, and a mating interface at the other end.

2. Description of the Related Art

FPC is a medium used for data transmission between computers and the peripherals connected thereto. U.S. Pat. No. 6,755,682 issued to Kunishi et al. on Jun. 29, 2004, discloses a conventional FPC connector which includes an insulative housing forming a receiving recess for receiving an inserted FPC, a plurality of terminals which are arranged across a width thereof and with a contacting portion protruding into the receiving recess. An actuator is pivotally movable relative to the housing and can be operated between an opened position at which the FPC is permitted to insert into the receiving recess and a closed position at which said FPC is pressed against with the contacting portion of the terminal. This typical FPC connector is normally soldered onto a printed circuit board, and with its mating interface to receive an FPC therein. However, when we need mate an FPC and another mating connector, we would use additional numbers of connectors that would occupy more area on the PCB.

U.S. Pat. No. 5,738,545 issued to Igarashi et al. on Apr. 14, 1998, discloses a conventional connection device or interconnecting with an FPC and a mating connector mounted on a Printed Circuit Board (PCB). More particularly, the connection device is used for an electrical adapter between of the FPC and the mating connector. However, the connection device could only be interconnected between the FPC and the mating connector which is not easily modified to apply in another field application, for example another connection device which could create an interconnection between the PCB and at least one of the different interfaces.

Therefore, an improved electrical connector is desired to overcome the disadvantages of the related arts.

### SUMMARY OF THE INVENTION

An object of the present invention is to provide an electrical connector which is soldered to a PCB and electrically connecting with two different interfaces for transmitting signals between the PCB and at least one of the objects.

In order to achieve the above-mentioned object, an electrical connector for electrically mating with two different mating interfaces in accordance with a preferred embodiment of the present invention includes an insulative housing defining a first and a second mating spaces located at opposite ends, a plurality of contact terminals received in the insulative housing each of which integrally defines an upper beam, a lower beam, and a fulcrum portion connecting the beams at middle thereof, an actuator pivotally assembled on the housing and capable of rotating between an opened position in which one of the mating spaces is accessible, and a closed position in which the actuator is substantially covering said mating space. Each contact terminal forms a first contact portion extending toward a first mating space from the fulcrum portion, a second contact portion extending toward a second mating space from the fulcrum portion, and a soldered portion solderable onto a PCB which the electrical connector located thereon or therein.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the preferred embodiment of the present invention which is located on a PCB to connect with an FPC and a plug connector;

FIG. 2 is a perspective view of the electrical connector of FIG. 1;

FIG. 3 is another perspective view of the electrical connector of FIG. 1;

FIG. 4 is an exploded view of the electrical connector of FIG. 2;

FIG. 5 is a perspective view of a terminal of the electrical connector; and

FIG. 6 is a cross-section of the electrical connector taken along line 6-6 of FIG. 1, which is soldered onto the PCB and mates with the plug connector and the FPC.

### DETAILED DESCRIPTION OF THE INVENTION

Reference will now be made to the drawing figures to describe the preferred embodiment of the present invention in detail.

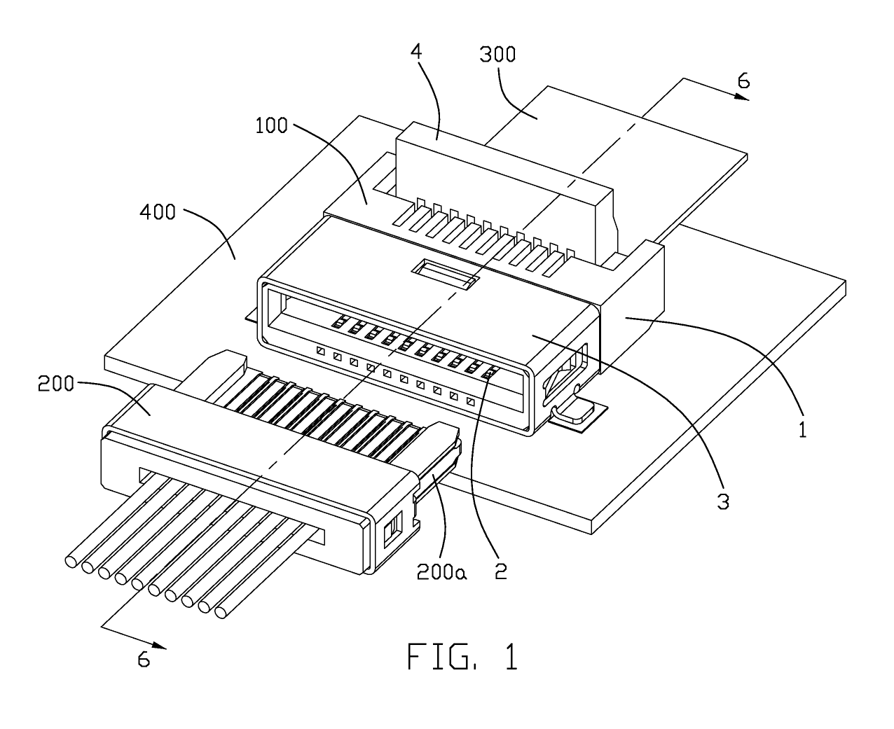

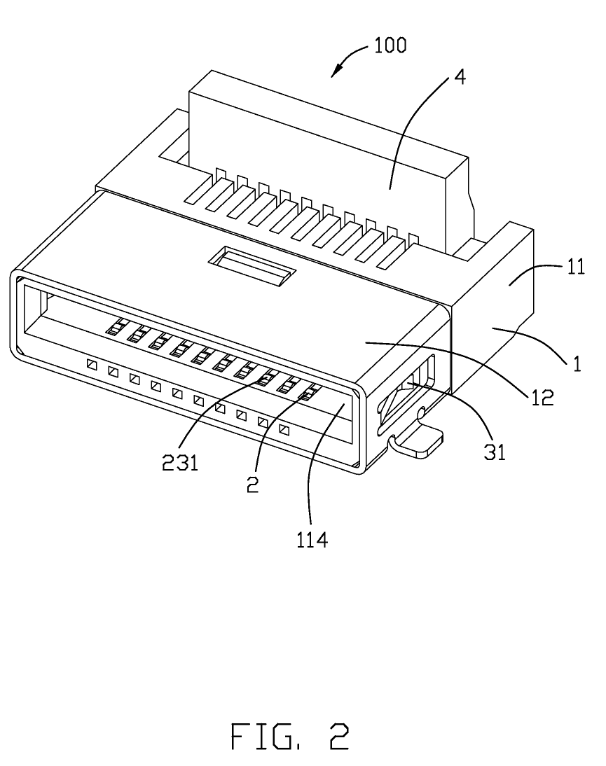

Referring to FIGS. 1 and 2, an electrical connector 100 could electrically mate with a mating connector 200 and an FPC (flexible circuit board) 300 by separate mating port, and includes an insulative housing 1 formed with a first mating portion 11 and a second mating portion 12 located at opposite ends thereof and in communicated with the first mating portion 11.

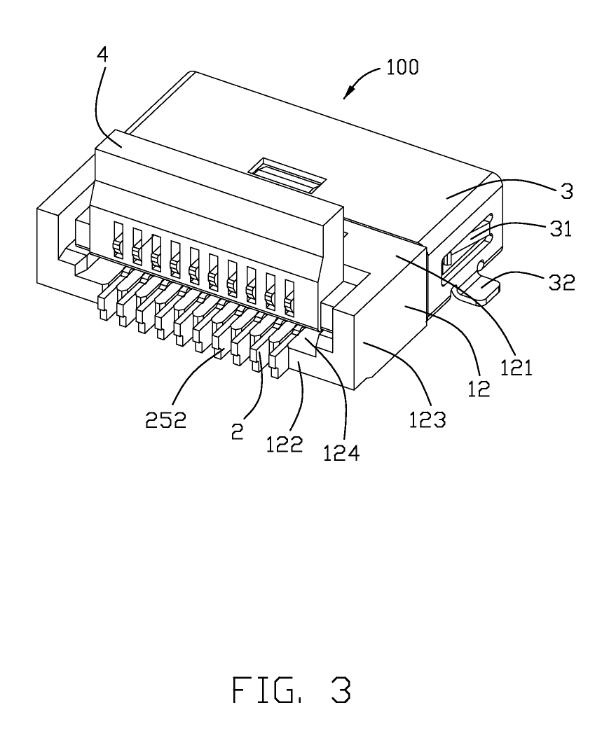

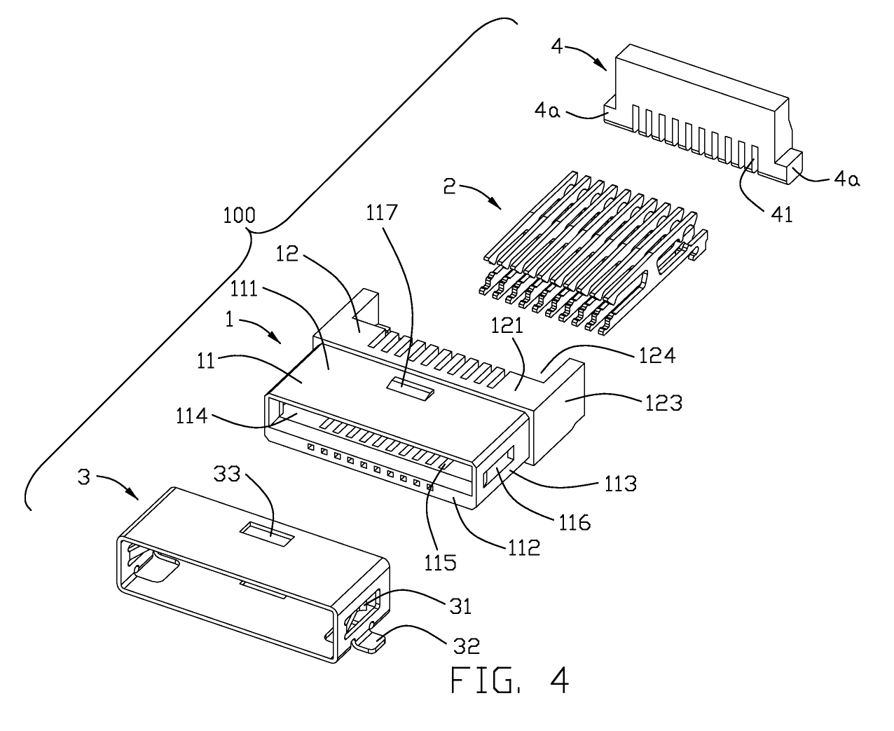

Referring to FIGS. 3 and 4, the first mating portion 11 includes a mating port 114 surrounded by a pair of first side walls 111, 112 and a pair of first end walls 113 integrally connected with both ends of the first side walls 111, 112 for receiving the mating connector 200. The second mating portion 12 has a recess 124 formed by a pair of second side walls 121, 122 and a pair of second side walls 123 in communicating with ends of the second side walls 121, 122 for accepting the FPC 300. The electrical connector 100 is assembled on a PCB 400, thereby the insulative housing 10 is laid on the PCB 400. The first side walls 111, 112 define a plurality of grooves 115 extending through the second side walls 121, 122 and in communicating with the mating port 114 and the recess 124. A plurality of terminals 2 are inserted into the corresponding grooves 115 and received and retained therein from a side that the second mating portion 12 located.

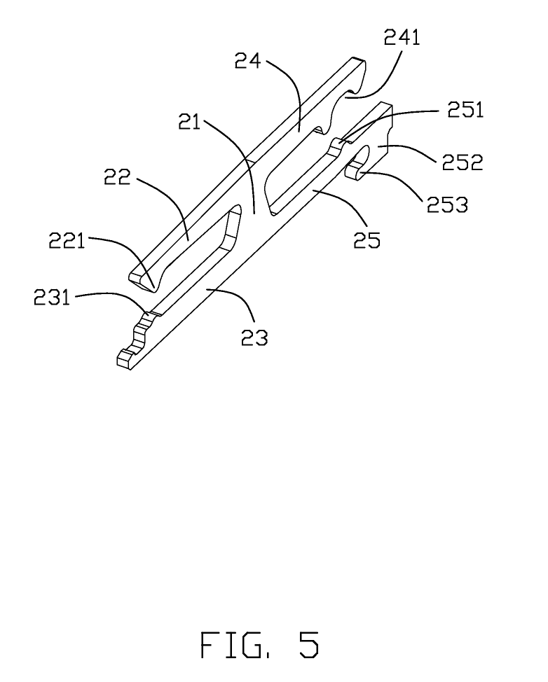

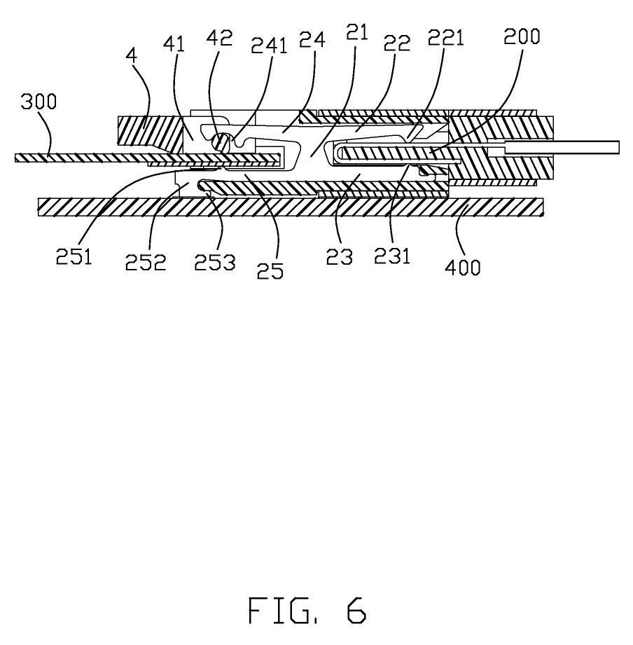

Referring to FIGS. 4 to 6, each terminal 2 integrally includes an upper beam 2a retained in the upper side walls 111, 121, a lower beam 2b received in the lower side walls 112, 122 and a fulcrum portion 21 connecting the upper beam 2a and the lower beam 2b at middle thereof, thereby the terminal 2 forms substantially a horizontal H-shaped configuration. The terminal 2 forms a pair of first contacting arms 22, 23 both extending forwards into the mating port 114 from both end of the fulcrum portion 21. One first contacting arm 22 of the upper beam 2a has a first engaging portion 221 at front end thereof, and is opposite to a first contacting portion 231 defined by another first contacting arm 23 at front end thereof. The first engaging portion 221 and the first contacting portion 231 are protruded into the mating port 114, thereby the mating connector 200 that plugged into the mating port 114 is sandwiched between the first contact portion 231 and first engaging portion 221 for establishing electrical connection of two connectors 100, 200.

The terminal 2 further defines a pivot arm 24 and a second contacting arm 25 both extending rearwards into the recess 124 from both end of the fulcrum portion 21. The second contacting arm 25 includes a second contacting portion 251 protruded into the recess 124 from the groove 115 of the side wall 122 and a soldered portion 252 extending outwards and solderable onto the PCB 400 from the second contacting portion 251. The soldered portion 252 defines a barb 253 for securely holding the second side wall 122. The pivot arm 24 of the upper beam 2a defines a cam receiving portion 241 at rear end thereof.

The electrical connector 100 further includes an actuator 4 pivotally assembled on the housing 1 and terminal 2 and capable of rotating between an opened position, in which the recess 124 is accessible to receive the FPC therein, and a closed position in which the actuator 4 is substantially covering said recess 124 to depress the received FPC 300 toward the second contacting portion 251 of the terminal 2. The actuator 4 defines a pair of axis 4a moveably assembled on the both ends of the insulative housing 1, a plurality of holes 41 for receiving the pivot arm 24 and a plurality of cam portion 42 formed by the holes 41 and outer edge of the actuator 4 received in and engaging with the cam receiving portion 241 of the pivot arm 24. The cam receiving portion 241 is double-hump-shaped configuration for preventing the cam portion 42 of the actuator 4 received therein away from its intended position. When the actuator 4 moves to the closed position, it could press the FPC 300 inserted in the recess 124 downwards against the second contacting portion 251 of the terminal 2 for electrically connecting the electrical connector 100 with the FPC 300.

Along with the actuator 4 rotates between the opened position and closed position, the upper beam 2a could be also movable or stationary relative to the lower beam 2b. If the upper beam 2a is moveable, the first contact portion 231 and first engaging portion 221 could securely sandwich the mating connector 200 after the first engaging portion 221 moves downwards as upward movement of the pivot arm 24 pressed by the cam portion 42 of the actuator 4. The mating connector 200 is plugged in the mating port 114 as a lower inserting force (LIF) when the upper beam 2a is stationary relative to the lower beam 2b. The electrical connector 100 with two different interfaces establishes a three-way interconnection of between the PCB 400 and at least one of the mating connector 200 and the FPC 300.

The electrical connector 100 further includes a metallic shell 3 shrouding the mating port 114 for preventing the electrical connector 100, especially the first mating portion 11 from EMI. The metallic shell is provided with a plurality of retaining holes 33 for securely holding with a plurality of protruding tuber 117 of the first side walls 111, 112. The metallic shell 3 defines a pair of resilient finger 31 extending inwards along a front-to-rear direction in which the mating connector 200 is plugged into the mating port 114, and a pair of pads 32 at both ends thereof solderable onto said PCB 400 for forming a grounding trace. The end wall 113 includes a window 116 for extension of the resilient finger 31 therethrough to the mating port 114, thereby the shell could electrically connecting with a pair of grounding terminals 200a of the mating connector 200.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector for electrically mating with two different mating interfaces comprising:
an insulative housing defining a first and a second mating spaces located at opposite ends;
a plurality of contact terminals received in the insulative housing and each contact terminal integrally comprising an upper beam, a lower beam, and a fulcrum portion connecting the upper beam and the lower beam at middle thereof;
an actuator pivotally assembled on the housing and capable of rotating between an opened position, in which one of the mating spaces is accessible, and a closed position, in which the actuator is substantially covering said mating space; and
each contact terminal forms a first contact portion extending toward a first mating space from the fulcrum portion, a second contact portion extending toward a second mating space from the fulcrum portion, and a soldered portion solderable onto a PCB which the electrical connector located thereon or therein.

2. The electrical connector as described in claim 1, wherein the second mating space is a recess for receiving a flexible circuit board, in which a pair of axis of the actuator is moveably assembled on the both ends thereof.

3. The electrical connector as described in claim 1, wherein the upper beam is stationary relative to the lower beam.

4. The electrical connector as described in claim 1, wherein the upper beam is moveable relative to the lower beam.

5. The electrical connector as described in claim 1, wherein each contact terminal forms a horizontal H-shaped configuration.

6. The electrical connector as described in claim 3, wherein the upper beam comprises a cam receiving portion engaging with a cam portion of the actuator received therein.

7. The electrical connector as described in claim 6, wherein the second contact portion is located one end of the lower beam and opposite to the cam receiving portion for connecting with the flexible circuit board received in the second mating space.

8. The electrical connector as described in claim 7, wherein the soldered portion extends outwards from the second contacting portion.

9. The electrical connector as described in claim 7, wherein the lower beam comprises a first contact portion located at another end thereof opposite to a first engaging portion defined by the upper beam, thereby another mating object received in the first mating space is sandwiched between the first contact portion and first engaging portion.

10. The electrical connector as described in claim 7, further comprising a metallic shell shrouding the first mating space for preventing the electrical connector from EMI.

11. The electrical connector as described in claim 10, wherein the metallic shell comprises a pair of pads at both ends thereof solderable onto said PCB.

12. The electrical connector as described in claim 10, wherein the metallic shell retains with the insulative housing and further comprises at least one of resilient finger extending inwards along a mating direction in which corresponding mating object is plugged into the first mating space.

13. An interconnection system comprising
an electrical connector forming a first and a second mating spaces at both ends thereof and comprising an insulative housing and a plurality of terminals retained in the housing, each of which integrally defining a first contacting portion and a second contacting portion respectively extending into the first and the second mating spaces;
the electrical connector further comprising an actuator pivotally assembled on the insulative housing and capable of rotating between an opened position in which the flexible printed circuit board is permitted inserted into the second mating spaces, and a closed position in which the actuator is substantially closing-in said mating space and pressing the flexible printed circuit board downwards against the second contacting portion of the terminal;
a mating connector plugged into the first mating space; and
a flexible circuit board received in the second mating space.

14. The interconnection system as described in claim 13, wherein each terminal integrally comprise an upper beam, a lower beam, and a fulcrum portion connecting the upper beam and the lower beam at middle thereof, thereby forms a horizontal H-shaped configuration.

15. The interconnection system as described in claim 14, wherein the upper beam is stationary relative to the lower beam.

16. The interconnection system as described in claim 14, wherein the upper beam is moveable relative to the lower beam.

17. The interconnection system as described in claim 14, wherein the upper beam comprises a cam receiving portion at one end thereof engaging with a cam portion of the actuator received therein.

18. The interconnection system as described in claim 14, wherein the cam receiving portion is double-hump-shaped configuration, the cam portion of the actuator is received therein.

19. An electrical connector assembly comprising:
an electrical connector defining opposite first and second mating ports;
a plurality of contacts disposed in the housing, each of said contacts defining a pivotal arm with a fulcrum at a middle region and opposite first and second end sections respectively extending into the first and second mating ports so as to perform substantially a lever function essentially pivotal about said fulcrum;
an actuator rotatably mounted to the housing around the second mating port to cooperate with the second end section, between an open position, where the pivotal arm is in a relatively relaxed manner, and a closed position, wherein the pivotal arm is in a relatively tensioned manner;
an FPC (Flexible Printed Circuit) inserted into the second mating port and tightly abutting against and electrically connecting the contact around the second end section when said actuator is located in the closed position; and
an electronic part inserted into the first mating port and tightly abutting against and electrically connecting to the contact around the first end section when said actuator is located in the closed position.

20. The electrical connector assembly as claimed in claim 19, wherein each of said contacts further includes a mounted section around a mounting face for securing to a printed circuit board on which said mounting face is seated.
